(19) United States
(12) Patent Application Publication
(10) Pub. No.: US 2007/0019895 A1
(43) Pub. Date: Jan. 25, 2007

(54) Spherical bearing arrangement

(76) Inventors: Paul Raymond Smith, Lincoln (GB); Jerome Gourdl, Lincoln (GB)

Correspondence Address: KLARQUIST SPARKMAN, LLP, 121 SW SALMON STREET, SUITE 1600, PORTLAND, OR, 97204, US

(21) Appl. No.: 10/551,270

(22) PCT Filed: Mar. 25, 2004
(86) PCT No.: PCT/GB04/01295

§ 371 Date: May 30, 2006

(30) Foreign Application Priority Data
Mar. 31, 2003 (GB) 0307425.9

(51) Int. Cl. F16C 23/04

(52) U.S. Cl. 384/192

(57) ABSTRACT

A spherical bearing arrangement (1) having a bearing housing (3) and a ball (4) located therein, the bearing housing (3) having an outer housing (5), an inner housing (6) and an annular elastomeric portion (7) sandwiched between the housings (5,6) and a method of making the same comprising the steps of: swaging an inner housing (6) onto a ball (4); providing an annular elastomeric portion (7) around an outer surface of the inner housing (6); and swaging an outer housing onto the elastomeric portion (7).

This invention relates to a spherical bearing arrangement and more particularly to a spherical bearing incorporating an elastomeric portion.

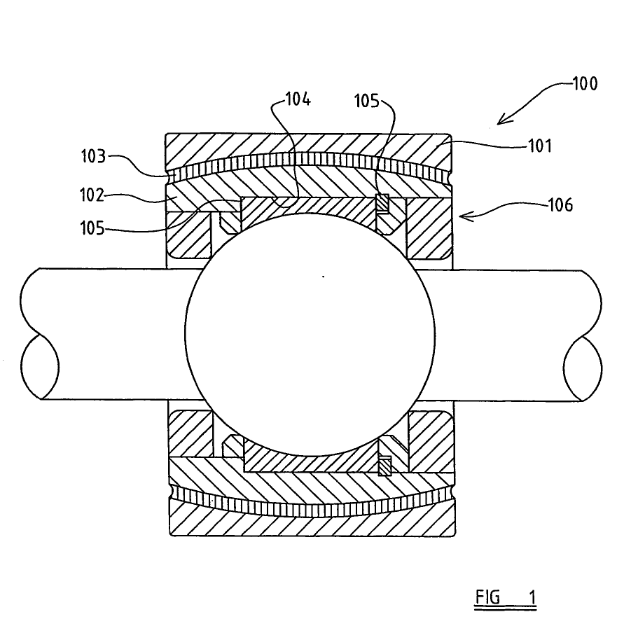

GB-A-2 263 948 discloses a so-called hybrid bearing 100 comprising an outer and middle housing 101,102 between which is sandwiched an annular rubber layer 103. The inner surface 104 of the middle housing 102 is formed with steps 105 to receive a multi-part inner housing 106 which is constructed within the middle housing 102. In the particular example shown in FIG. 1 of the accompanying drawings of a hybrid bearing, the multi-part inner housing 106 is assembled and pushed into the middle housing 102 which has the rubber layer 103 bonded to its outer surface. The outer housing 101 is then swaged and bonded onto the rubber layer 103.

This construction is disadvantageous because it adds approximately 15% in diameter to a comparable non-hybrid bearing because of the additional parts necessary to contain the elastomeric part of the hybrid bearing. It is an object of the present invention to reduce the size of hybrid bearings and also to provide a method of manufacture which is simpler than conventional methods such as that disclosed in GB 2 263 948.

Accordingly, one aspect of the present invention provides a spherical bearing arrangement having a bearing housing and a ball located therein, the bearing housing having an outer housing, an inner housing and an annular elastomeric portion sandwiched between the housings.

Another aspect of the present invention provides a method of manufacturing a spherical bearing comprising the steps of: swaging an inner housing onto a ball; providing an annular elastomeric portion around an outer surface of the inner housing; and swaging an outer housing onto the elastomeric portion.

In order that the present invention may be more readily understood, embodiments thereof will now be described, by way of example, with reference to the accompanying drawings, in which:

FIG. 1 is a schematic cross-section of a spherical bearing arrangement not in accordance with the present invention; and

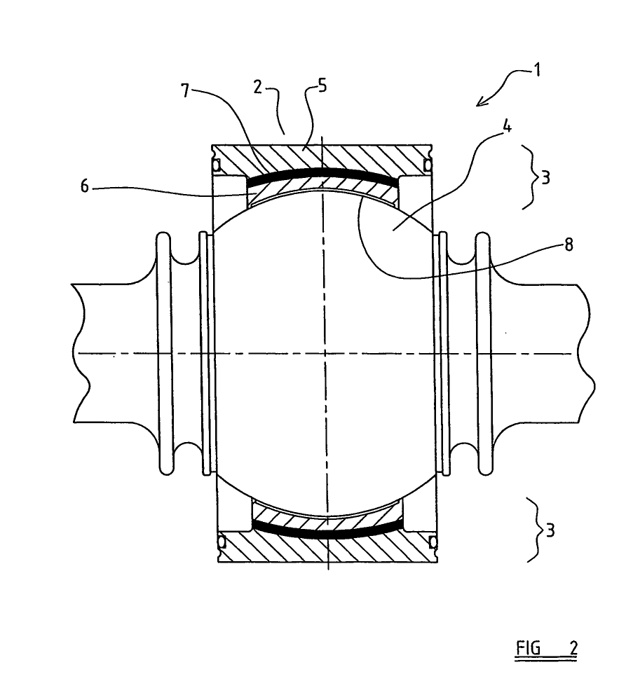

FIG. 2 is a spherical bearing arrangement embodying the present invention.

Referring now to FIG. 2 of the drawings, a bearing arrangement 1 embodying the present invention is shown and comprises a spherical bearing 2 having a bearing housing 3 and a ball 4 located therein, the bearing housing 3 having a rigid steel outer housing 5 and a rigid steel inner housing 6 between which is sandwiched an annular elastomeric portion 7, in this example, a rubber sleeve bonded to both housings 5,6. The outer housing 5 of the bearing housing may be securely held in an interference fit hole (being an interference fit hole because the internal diameter of the hole is less than the outer diameter of the outer housing 5).

Preferably, a self-lubricating liner 8 is provided on the inner surface of the inner housing 6 in contact with the ball 4. Alternatively, the inner housing 6 and ball 4 may be in direct contact with one another.

The bearing is manufactured as follows. Firstly, the inner housing 6 is swaged onto the ball 4. The elastomeric portion 7, the rubber layer, is then bonded to the inner housing, preferably by an injection process. 4. Finally, the outer housing 5 is swaged onto the inner housing 6, sandwiching the rubber layer 7 between the housings 5,6. Preferably, in addition to being swaged onto the rubber layer 7 around the inner housing 6, a layer of adhesive is applied between the outer housing 5 and rubber layer 7 by which the rubber layer 7 is bonded to the outer housing 5.

The liner 8 is not essential—the inner housing 6 and the ball 4 are both happily manufactured from a metal or metal alloy with the inner housing in direct contact with the ball.

The resultant hybrid bearing housing 3 has three main components, none of which need be multi-part components and, because of the small number of components, there is a significant space saving because the size of the outer diameter of the housing has been reduced. Comparing the example of the invention shown in FIG. 2 with the conventional hybrid bearing shown in FIG. 1, it will be appreciated that the invention allows the entire middle housing 102 shown in FIG. 1 to be dispensed with by adopting a simpler manufacturing process which leads to a reduction in the diameter of the bearing housing.

The spherical bearing has inner and outer housings 5, 6 between which are sandwiched the annular elastomeric portion. The housings and the elastomeric portion surround, capture and house the ball. Referring to FIG. 2 of the drawings, it will be noted that the ball has a diameter and the housings and the annular elastomeric portion surround that diameter at the equator of the ball. Both the inner housing and the elastomeric portion are curved around the ball—again see FIG. 2. It should be noted that, due to the curvature of the elastomeric portion and the inner housing around the ball, the spherical bearing embodying the present invention is able to absorb relative movement between the ball and the outer housing both in the radial direction and in the axial direction. Thus, in embodiments of the invention, because of the curvature of the elastomeric portion, there is also an element of compression of the elastomeric element between the inner and outer housings during any axial loading on the spherical bearing.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of manufacturing a spherical bearing comprising:
swaging an inner housing onto a ball to curve the inner housing around the ball and surround the equator of the ball;
providing an annular elastomeric portion around an outer surface of the inner housing, the annular elastomeric portion also curving around the ball and surrounding the equator of the ball; and
swaging an outer housing onto the elastomeric portion.

2. A method according to claim 1, wherein the act of providing the annular elastomeric portion around the outer surface of the inner housing comprises bonding an elastomeric portion to the outer surface of the inner housing.

3. A method according to claim 2, wherein the elastomeric portion is applied by an injection process.

4. (canceled)

5. A spherical bearing arrangement having a bearing housing and a ball located therein, the bearing housing having an outer housing, an inner housing and an annular elastomeric portion sandwiched between the outer and inner housings, wherein:
the outer housing has an outer surface to allow the outer housing to be securely held in an interference fit hole;
the housings and the annular elastomeric portion surround the equator of the ball; and
the inner housing and the annular elastomeric portion are curved around the ball.

6. A bearing arrangement according to claim 5, wherein the elastomeric portion is bonded to the inner housing.

7. A bearing arrangement according to claim 6, wherein the elastomeric portion is bonded to the inner housing by an injection process.

8. A bearing arrangement according to claim 5, wherein the elastomeric portion is bonded to the outer housing.

9. A bearing arrangement according to claim 5, wherein a liner is provided on the inner housing in contact with the ball.

10. A bearing arrangement according to claim 9, wherein the liner is a self-lubricating liner.

11. A bearing arrangement according to claim 5, wherein the inner housing and ball are both manufactured from metal and the inner housing is in direct contact with the ball.

12. A bearing arrangement according to claim 5, wherein the elastomeric portion is rubber.

13. A bearing arrangement according to claim 6, wherein the elastomeric portion is bonded to the outer housing.

14. A bearing arrangement according to claim 7, wherein the elastomeric portion is bonded to the outer housing.

15. A bearing arrangement according to claim 6, wherein a liner is provided on the inner housing in contact with the ball.

16. A bearing arrangement according to claim 7, wherein a liner is provided on the inner housing in contact with the ball.

17. A bearing arrangement according to claim 8, wherein a liner is provided on the inner housing in contact with the ball.

18. A bearing arrangement according to claim 6, wherein the inner housing and ball are both manufactured from metal and the inner housing is in direct contact with the ball.

19. A bearing arrangement according to claim 7, wherein the inner housing and ball are both manufactured from metal and the inner housing is in direct contact with the ball.

20. A bearing arrangement according to claim 8, wherein the inner housing and ball are both manufactured from metal and the inner housing is in direct contact with the ball.

21. A bearing arrangement according to claim 6, wherein the elastomeric portion is rubber.
